(19) United States
(12) Patent Application Publication
(10) Pub. No.: US 2009/0168985 A1
(43) Pub. Date: Jul. 2, 2009

(54) METHOD AND APPARATUS FOR AN INTERNET PROTOCOL MULTIMEDIA SUBSYSTEM-BASED THREE-WAY CALL

(75) Inventors: Mei Yu, Roselle, IL (US); Thomas G. Hallin, Erie, CO (US); Anjum Jeelani, Bangalore (IN); Srinidhi N, Bangalore (IN)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/258,614

(22) Filed: Oct. 27, 2008

Related U.S. Application Data
(60) Provisional application No. 61/018,008, filed on Dec. 31, 2007.

(51) Int. Cl. H04M 3/42

(52) U.S. Cl. 379/202.01

(57) ABSTRACT

A communication system provides for an Internet Protocol Multimedia Subsystem (IMS)-based three way call. A mobile station (MS) that receives an invitation to participate in a call determines to switch the call to a three way call. The MS conveys a request to an IMS network to switch the call to a conference call. An IMS network server receives the request, determines a unique identifier for the conference call, and provides the conference call identifier to the MS via one or more of a Session Initiation Protocol Refer message, Message message, and Notify message. In response to receiving the conference call identifier, the MS dials into the conference call and requests that the call originator also dial in. The IMS network server then requests that the call originator dial in, and the call originator does so in response to the request.

### CROSS-REFERENCE TO RELATED APPLICATION

This application claims priority from provisional application serial No. 61/018,008, attorney docket no. CE16784T, entitled “METHOD AND APPARATUS FOR AN INTERNET PROTOCOL MULTIMEDIA SUBSYSTEM-BASED THREE-WAY CALL,” and filed Dec. 31, 2007, which is commonly owned and incorporated herein by reference in its entirety.

### FIELD OF THE INVENTION

The present invention relates generally to wireless communication systems, and more specifically to an Internet Protocol Multimedia Subsystem (IMS)-based three-way call.

### BACKGROUND OF THE INVENTION

Three-way calling is a basic Public Switched Telephone Network (PSTN) and cellular feature. In such systems, three-way calling typically starts out as a call waiting scenario and then, at some point, a network server (mobile or land switch) converts the call to a three-way call based on a subscriber request.

However, anchoring a three-way call in a Session Initiation Protocol (SIP)-based network is problematic. A proposed use, in SIP systems, of a contact header comprising a dynamically assigned conference Uniform Resource Indicator (URI) as the address for a three-way call will not work in an IMS network as application servers, which act as Back-to-Back User Agents (B2BUAs), can be chained together on both origination and termination paths and, pursuant to the standards, will each re-write the contact header. As a result, the conference call URI cannot propagate through the system. Furthermore, for a SIP call, the Real Time Protocol (RTP) media stream does not flow through a SIP server that sets up the call, making it difficult to offer a three-way call utilizing SIP signaling that is similar to a circuit switched three-way calling feature.

SIP-based communication systems and their transport Internet Protocol (IP)-based networks have moved a lot of traditionally centralized functions, such as media control, down to the end client itself. It is now possible for a fixed SIP-based client to act as media mixing point for multiple, such three or more, parties to a voice call. The quality of the voice depends, of course, on the client media mixing function and network bandwidth availability at the time. Due to limited IP transport bandwidth and a lack of end-to-end Quality of Service (QoS), a use of local client mixing has not been a very pleasant experience for an end user. As a result, for a cellular SIP client, because of the limited radio network throughput, it is unreasonable to expect the end client to do the media mixing.

Therefore, a need exists for a method and apparatus for implementing a three-way call that is set up via an IMS network and that includes network-based media mixing.

### BRIEF DESCRIPTION OF THE DRAWINGS

FIG. 1 is a block diagram of a wireless communication system in accordance with various embodiments of the present invention.

FIG. 2 is a block diagram of a mobile station of FIG. 1 in accordance with an embodiment of the present invention.

FIG. 3 is a block diagram of a Mobility Manager/Voice Call Continuity server of FIG. 1 in accordance with an embodiment of the present invention.

FIGS. 4A-4K are signal flow diagrams that illustrate a method executed by the communication system of FIG. 1 in setting up an Internet Protocol Multimedia Subsystem-based conference call in accordance with an embodiment of the present invention.

### DETAILED DESCRIPTION OF THE INVENTION

To address the need that exists for a method and apparatus for implementing a three-way call that is set up by an IMS network and that includes network-based media mixing, a communication system is provided that provides for an Internet Protocol Multimedia Subsystem (IMS)-based three way call. A mobile station (MS) that receives an invitation to participate in a call determines to switch the call to a three way call. The MS conveys a request to an IMS network to switch the call to a conference call. An IMS network server receives the request, determines a unique identifier for the conference call, and provides the conference call identifier to the MS via one or more of a Session Initiation Protocol Refer message, Message message, and Notify message. In response to receiving the conference call identifier, the MS dials into the conference call and requests that the call originator also dial in. The IMS network server then requests that the call originator dial in, and the call originator does so in response to the request.

Generally, an embodiment of the present invention encompasses a method for an IMS-based three way call. The method includes receiving a request from a conference call initiator to switch a call to a conference call, assigning a unique identifier to the conference call, and providing the conference call identifier to the conference call initiator via one or more of a Session Initiation Protocol Refer message, Message message, and Notify message.

Another embodiment of the present invention encompasses an IMS network server that is configured to receive a request from a conference call initiator to switch a call to a conference call, determine a unique identifier for the conference call, and provide the conference call identifier to the conference call initiator via one or more of a Session Initiation Protocol Refer message, Message message, and Notify message.

Yet another embodiment of the invention encompasses a mobile station (MS) capable of participating in an IMS-based three way call. The MS is configured to receive invitation to participate in a call, determine to switch the call to a three way call, convey a request to an IMS network to switch the call to a conference call, receive a unique identifier for the conference call from the IMS network via one or more of a Session Initiation Protocol Refer message, Message message, and Notify message, and dial into the conference call based on the received conference call identifier.

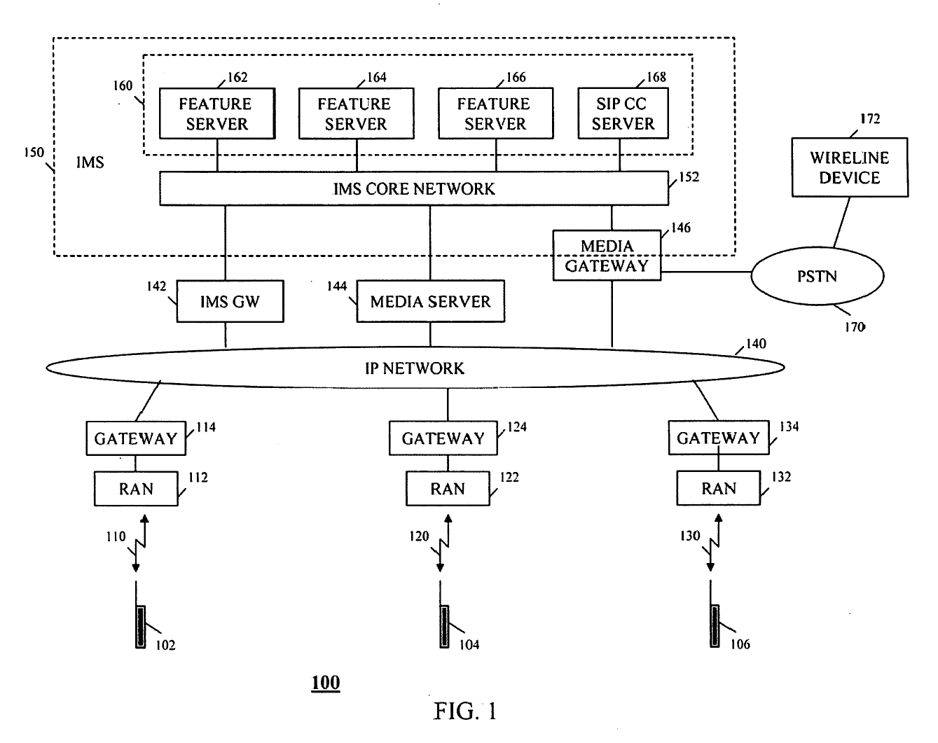

Turning now to the drawings, the present invention may be more fully described with reference to FIGS. 1-4K. FIG. 1 is a block diagram of a wireless communication system 100 in accordance with various embodiments of the present invention. Communication system 100 includes multiple mobile stations (MSs) 102, 104, 106 (three shown), for example but not limited to a cellular telephone, a radiotelephone, or a Personal Digital Assistant (PDA), personal computer (PC), or laptop computer equipped for wireless voice and data communications. In various radio technologies, a mobile station such as MSs 102 and 104 may be referred to as a user equipment (UE), a subscriber station (SS), an access terminal (AT), or the like. Each MS 102, 104, 106 is in wireless communication with a respective Radio Access Network (RAN) 112, 122, 132 via a respective air interface 110, 120, 130. Each air interface 110, 120, 130 includes a forward link that includes a pilot channel, at least one forward link traffic channel, and forward link common and dedicated signaling channels. Each air interface 110, 120, 130 further includes a reverse link that includes at least one reverse link traffic channel, reverse link common and dedicated signaling channels, and an access channel.

Each RAN 112, 122, 132 includes a transceiver (not shown), such as a Base Station Transceiver (BTS), an Access Point (AP), or a Node B, and may further include a controller (not shown), such as a Base Station Controller (BSC) or a Radio Network Controller (RNC). Each RAN 112, 122, and 132 is coupled to an Internet Protocol (IP)-based data network 140 via a respective gateway 114, 124, and 134. Each gateway 114, 124, 134 may comprise, by way of example, one or more of Mobile Switching Center (MSC), a Packet Data Serving Node (PDSN), a Serving GPRS Support Node (SGSN), a Gateway GPRS Support Node (GGSN), a Serving Gateway (Serving GWG), and a Public Data Network (PDN) Gateway.

Communication system 100 further includes an Internet Protocol Multimedia Subsystem (IMS) 150 that is coupled to data network 140 via each of an IMS Gateway 142, a media server 144, and a media gateway 146. 146. Media server 144 preferably comprises a Media Resource Function (MRF), which MRF includes a Media Resource Function Controller (MRFC) (not shown) and a Media Resource Function Processor (MRFP) (not shown), and provides media-related functions such as a playing of tones and announcements and conference call functionality such as voice and media mixing. Media gateway 146 preferably comprises one or more of a Media Gateway Control Function (MGCF) and a Media Gateway (MGW) and provides a connection to an external wireline circuit switched network 170, such as a Public Switched Telephone Network (PSTN), for gateways 114, 124, and 134 and IMS 150.

IMS 150 comprises an IMS core network layer 152 and an application layer 160. IMS core network layer 152 includes a Call Session Control Function (CSCF) (not shown). As is known in the art, the CSCF implements one or more of a Proxy CSCF (P-CSCF), a Serving CSCF (S-CSCF), and an Interrogating CSCF (I-CSCF). The CSCF serves as a centralized routing engine, policy manager, and policy enforcement point to facilitate the delivery of multiple real-time applications using IP transport. It is application-aware and uses dynamic session information to manage network resources (feature servers, media gateways, and edge devices) and to provide advance allocation of these resources depending on the application and user context. The I-CSCF is the contact point within an operator's network for all connections destined for a user of that network, or for a roaming user currently located within that network's service area. The S-CSCF is responsible for identifying the user's service privileges, selecting access to an application server coupled to the IMS network, and providing access to those servers. The P-CSCF is the SIP signaling contact point in the IMS core network for an MS, such as MSs 102, 104, and 106. The P-CSCF is responsible for forwarding Session Initiation Protocol (SIP) registration messages from a subscriber's endpoint, that is, for forwarding call set-up requests and responses to the S-CSCF. P-CSCF maintains a mapping between a logical subscriber SIP Uniform Resource Identifier (URI) address and an MS IP (Internet Protocol) address and a security association for both authentication and confidentiality.

Application layer 160 includes multiple application servers, and in particular multiple feature servers 162, 164, and 166 and a Session Initiation Protocol Call Control (SIP CC) server 168 that are each in communication with IMS core network 152. In other embodiments of the invention, the SIP CC server 168 functionality described herein may be implemented in one of the features servers 162, 164, 166, and preferably a feature server serving an originating MS, for example, MS 102 and feature server 162. Each of servers 162, 164, and 166 acts as a User Agent (UA) for a respective MS 102, 104, 106. Thus, when two of the MSs, such as MSs 102 and 104, exchange SIP messaging, the messaging passes through the two feature servers serving the two MSs, that is, feature servers 162 and 164, and the two feature servers 162, 164 may be referred to as Back-to-Back User Agents (B2BUAs).

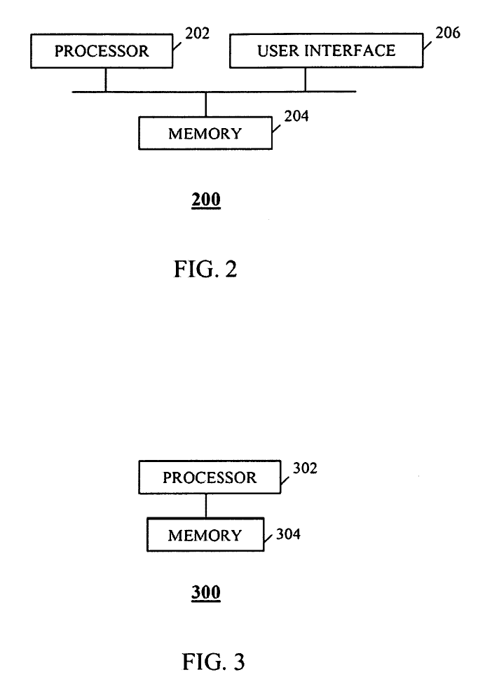

Referring now to FIG. 2, an architecture of an MS 200, such as MSs 102, 104, and 106 is provided in accordance with an embodiment of the present invention. MS 200 includes a processor 202, such as one or more microprocessors, microcontrollers, digital signal processors (DSPs), combinations thereof or such other devices known to those having ordinary skill in the art, which processor is configured to execute the functions described herein as being executed by MS 200. MS 200 further includes an at least one memory device 204, such as random access memory (RAM), dynamic random access memory (DRAM), and/or read only memory (ROM) or equivalents thereof, that is coupled to the processor and that maintains data and programs that may be executed by the associated processor and that allows the UE to perform all functions necessary to operate in communication system 100. The at least one memory device 204 further maintains routing information, that is, an address and more particularly a conference factory uniform resource indicator (CC_FACT_URI), for a conference call feature of SIP CC server 168. MS 200 further includes a user interface 206 that is coupled to processor 202. User interface 206 provides an interface with a user of the user terminal whereby the user may input information into the user terminal or receive information output by the user terminal and may include one or more of audio input and output interfaces, a keyboard, and a display screen, which display screen may have touch screen capability.

Referring now to FIG. 3, an architecture of a feature server 300, such as feature servers 162, 164, and 166, is provided in accordance with an embodiment of the present invention. Feature server 300 includes a processor 302, such as one or more microprocessors, microcontrollers, digital signal processors (DSPs), combinations thereof or such other devices known to those having ordinary skill in the art, which processor is configured to execute the functions described herein as being executed by the feature server. Feature server 300 further include an at least one memory device 304 that may comprise random access memory (RAM), dynamic random access memory (DRAM), and/or read only memory (ROM) or equivalents thereof, that maintain data and programs that may be executed by the associated processor and that allow the feature server to perform all functions necessary to operate in communication system 100. Preferably, feature server 300 is implemented by processor 302 based on programs and data maintained by at least one memory device 304.

The functionality described herein as being performed by MSs 102, 104, and 106 and by feature servers 162, 164, and 166 is implemented with or in software programs and instructions stored in the respective at least one memory device 204, 304 of the MSs and feature servers and executed by a processor 202, 302 of the MSs and feature servers. One of ordinary skill in the art realizes, however, that the embodiments of the present invention alternatively may be implemented in hardware, for example, integrated circuits (ICs), application specific integrated circuits (ASICs), and the like, such as ASICs implemented in one or more of the MSs and feature servers. Based on the present disclosure, one skilled in the art will be readily capable of producing and implementing such software and/or hardware without undo experimentation.

In order for MSs 102, 104, and 106 to engage in a voice call via RANs 112, 122, and 132, gateways 114, 124, and 134, and IMS 150, each of the MSs, RANs, and gateways operates in accordance with known wireless telecommunications protocols. Accordingly, RANs 112, 122, and 132 and gateways 114, 124, and 134 may operate in accordance with any wireless packet data communication system that supports packet data and SIP-based communication sessions, for example but not limited to the 3GPP (Third Generation Partnership Project) standard or later generations of the 3GPP standard, such as 3GPP LTE (Long Term Evolution), the 3GPP2 standard or later generations of the 3GPP2 standard, such as the 3GPP2 UMB (Ultra Mobile Broadband) standard, or any of the IEEE (Institute of Electrical and Electronics Engineers) 802.xx standards, for example, the 802.11, 802.15, or 802.16 or 802.20 standards.

Communication system 100 provides for three-way calling that is anchored in IMS 150. The communication system provides for a propagation of an assigned conference call identifier throughout the communication system, thereby permitting each MS, such as MSs 102 and 104, participating in a conference call, or three-way call, to know an address to dial into for the call. Communication system 100 facilitates propagation of such an identifier despite the involvement of multiple features servers, or B2BUAs, such as feature servers 162 and 164 serving MSs 102 and 104, respectively, in an IMS-based signaling path between a first MS, such as MS 102, that originates a call, and a second MS, such as MS 104, that switches the call to a conference call.

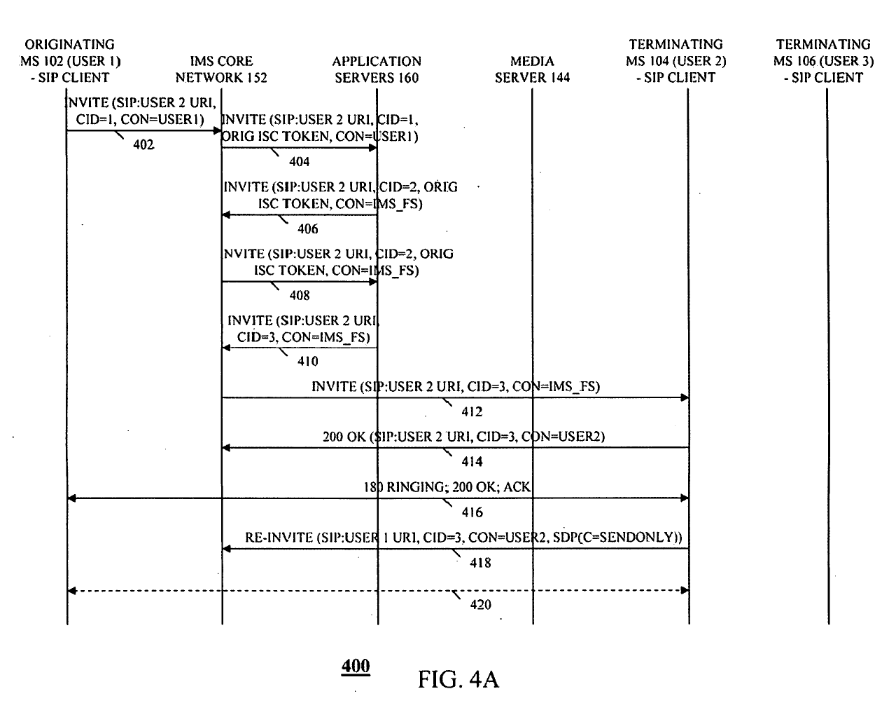

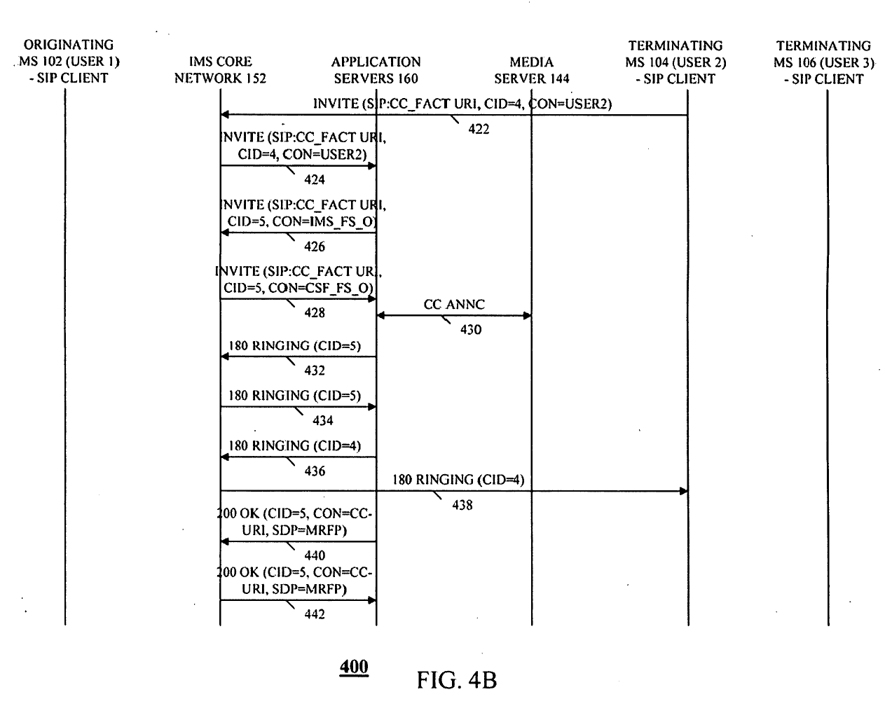

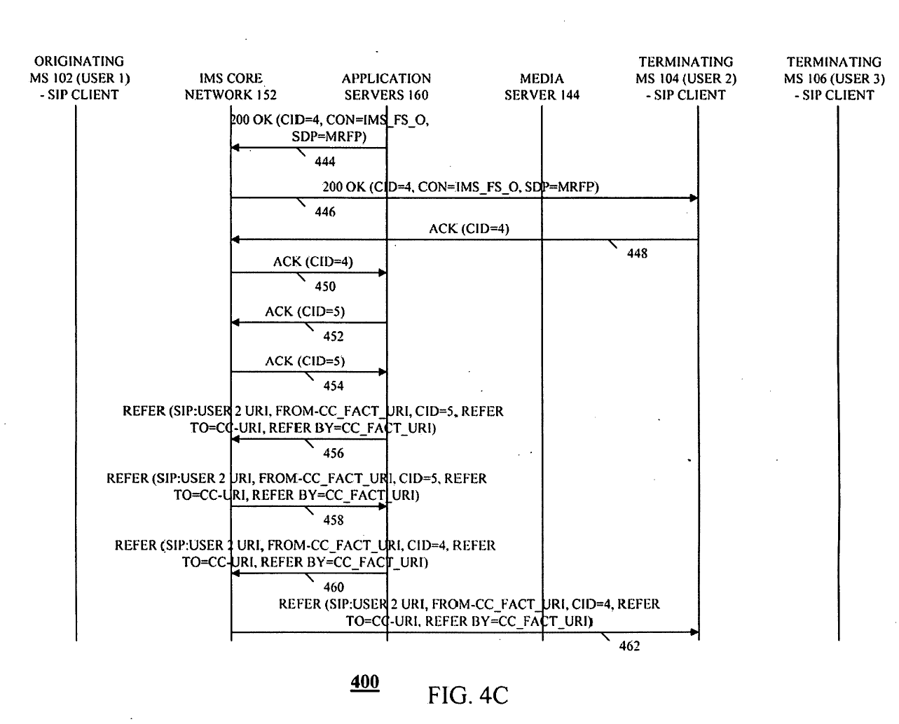

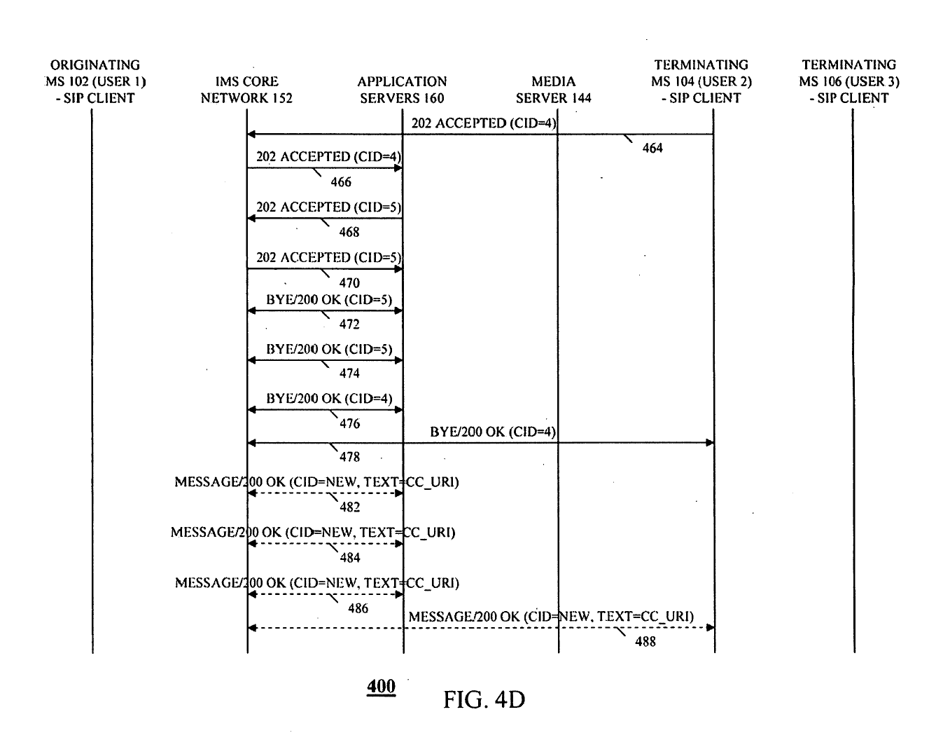

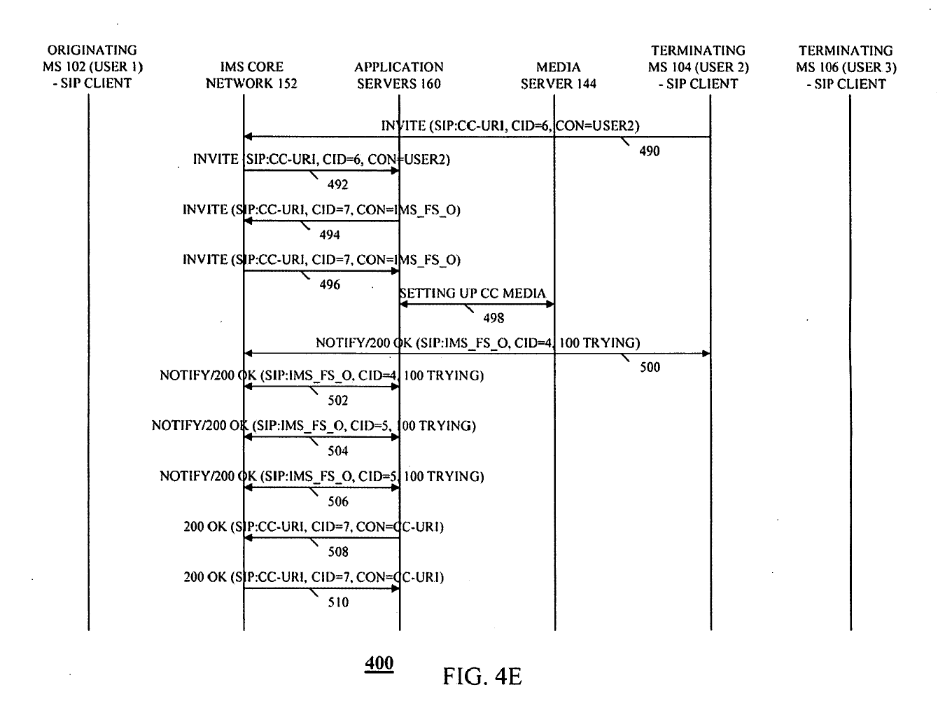

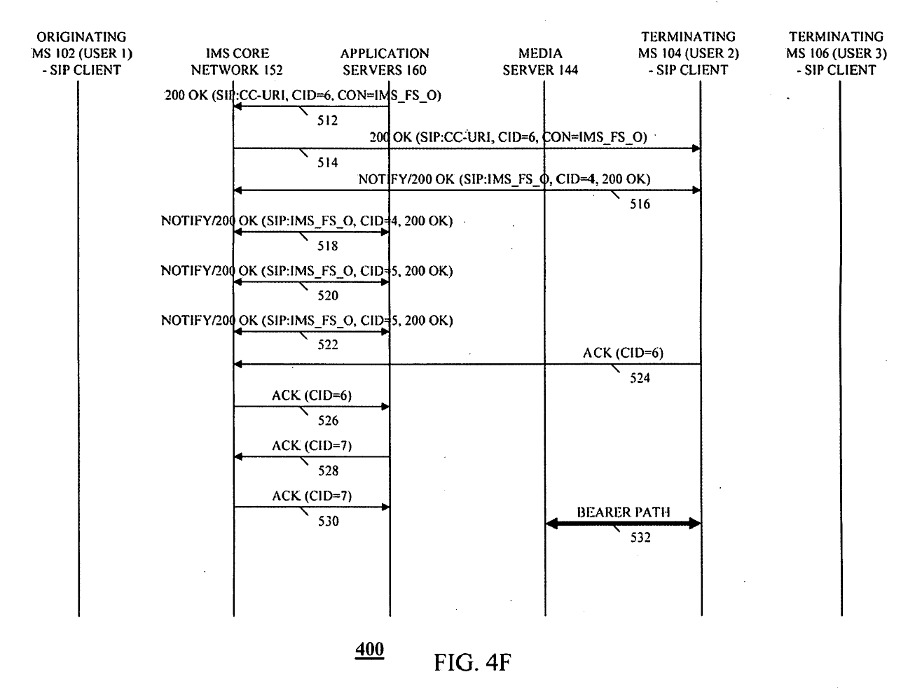

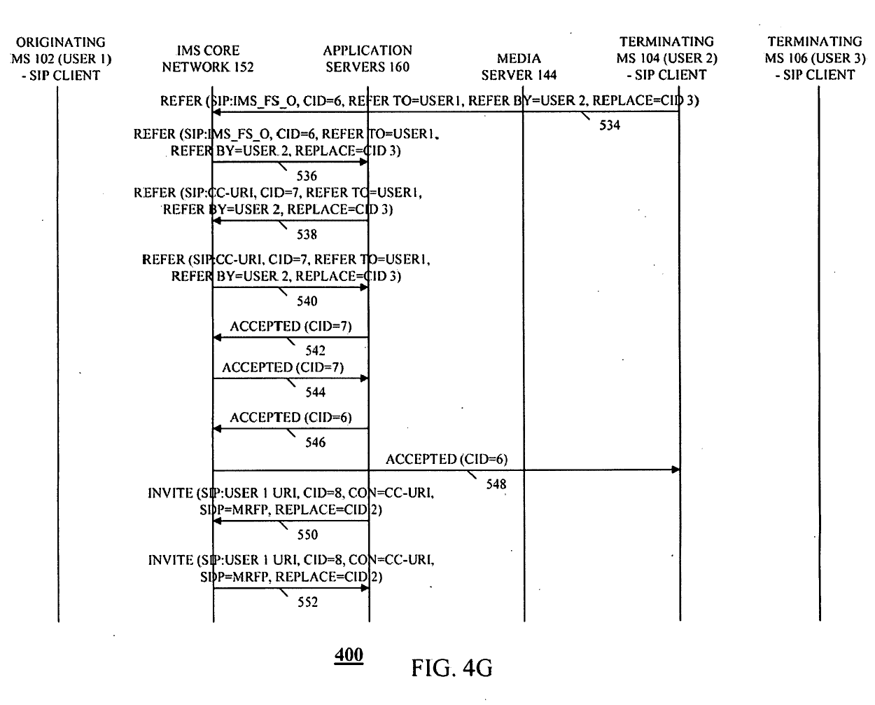

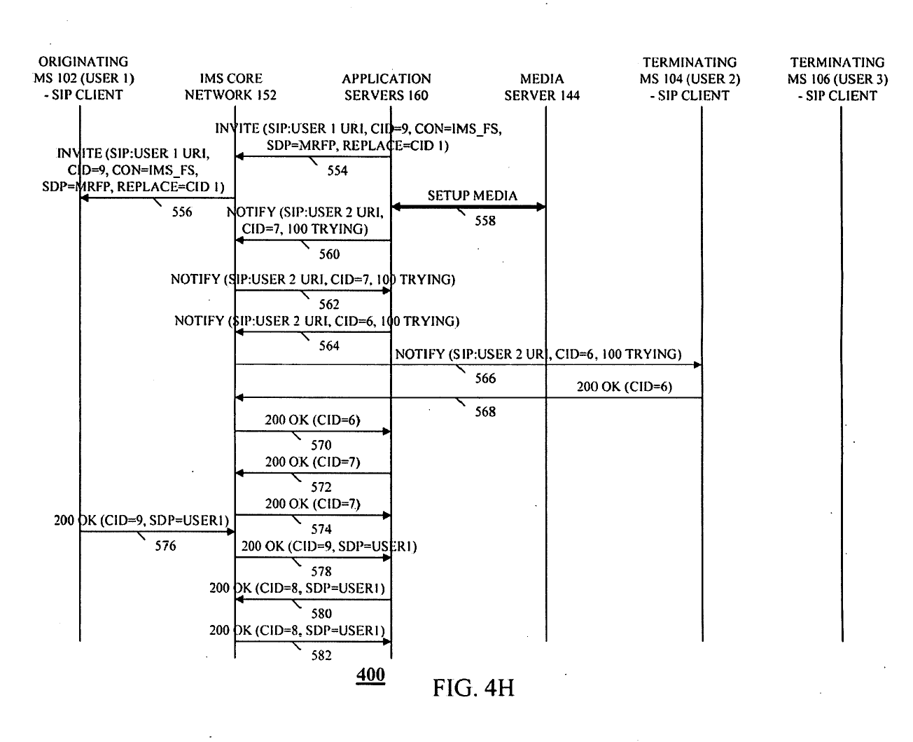

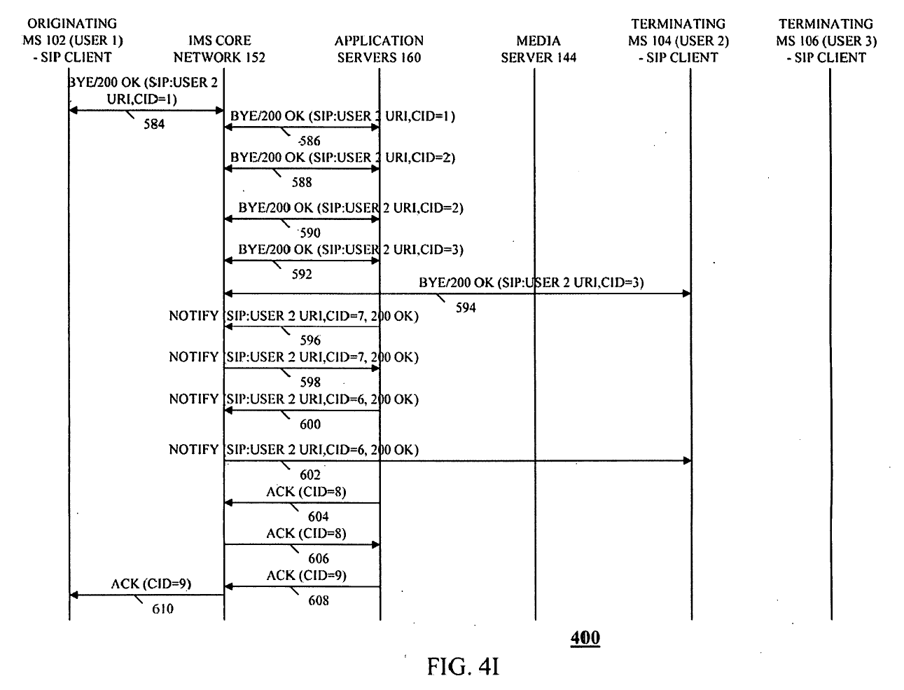

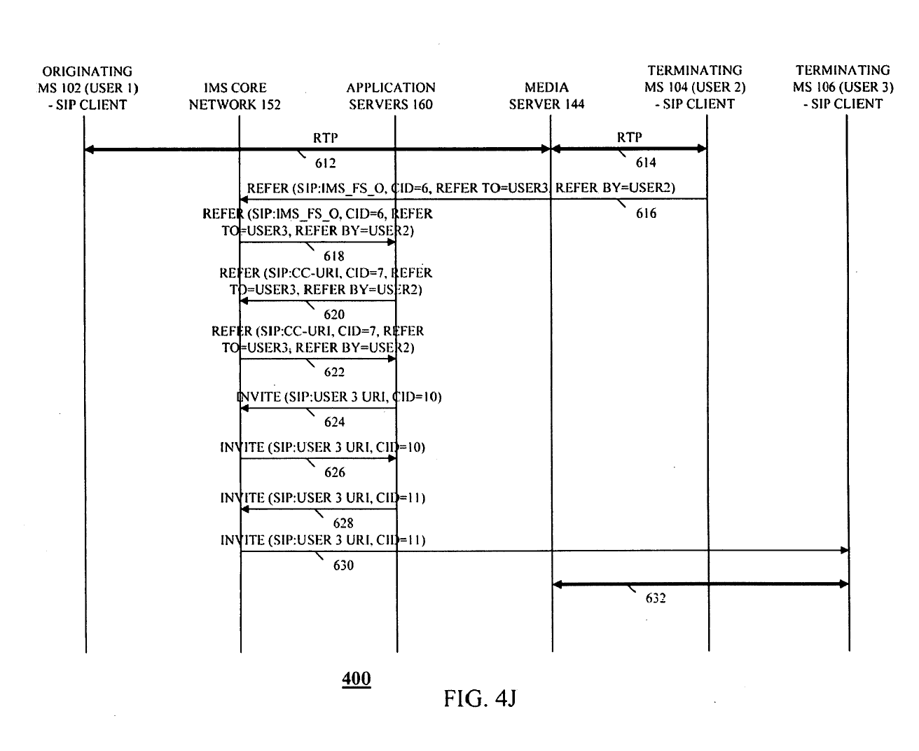

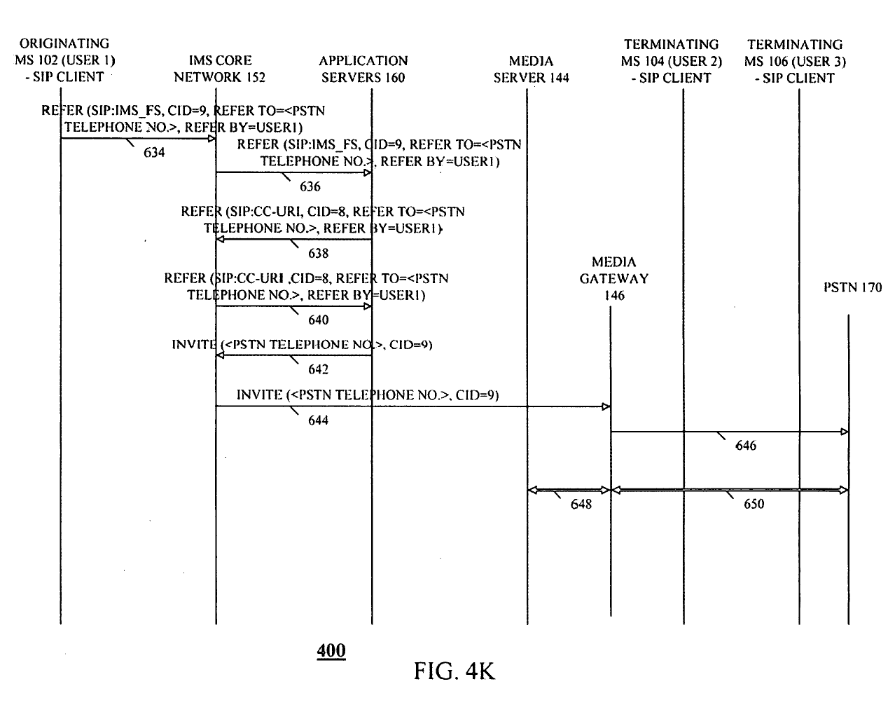

Referring now to FIGS. 4A-4K, a signal flow diagram 400 is provided that illustrates a method executed by communication system 100 in implementing a three-way call that is set up by IMS network 150 in accordance with an embodiment of the present invention. For purposes of more clearly describing the invention, it should be understood that MS 102 and feature server 162 communicate with each other via RAN 112, gateway 114, IP network 140, IMS gateway 142, and IMS core network 152, that MS 104 and feature server 164 communicate with each other via RAN 122, gateway 124, IP network 140, IMS gateway 142, and IMS core network 152, and that that MS 106 and feature server 166 communicate with each other via RAN 132, gateway 134, IP network 140, IMS gateway 142, and IMS core network 152. In addition, each of servers 162, 164, 166, and 168 communicates with the other servers and with media server 144 via IMS core network 152. While the messaging described below may be described with respect to two end points, such as an MS and a feature server, two feature servers, or a feature server and a media server, it should be understood that the messaging additionally passes through the above-described network elements.

Signal flow diagram 400 begins when a first MS, such as MS 102, attempts to set up an IMS telephony session with a second MS, or a first terminating MS, such as MS 104, via IMS 150. In setting up the session, originating MS 102 initiates a first dialogue by assigning a first connection identifier (‘CID=1’) to a connection at MS 102 with feature server 162. As is known in the art, a CID identifies a Medium Access Layer (MAC) layer connection for the communication session that is associated with the device or network entity generating the CID.

MS 102 then initiates the call by conveying a first session invitation, preferably a first Session Initiation Protocol (SIP) Invite, to MS 104. More particularly, originating MS 102 conveys 402, 404 to a first feature server 162 serving the MS, that is, feature server 162, the first session invitation, that is, the first SIP Invite, inviting the first called, or terminating, MS 104 to participate in a call. The session invitation includes a source identifier (‘CON=USER1’) associated with the calling party, that is, the sender of the invitation MS 102 (also referred to herein as ‘User 1’ or ‘User1’), a destination identifier, such as a Uniform Resource Indicator (URI), associated with the first called, or terminating, party, that is, MS 104 (also referred to herein as ‘User 2’ or ‘User2’) (‘SIP:USER 2 URI’), and the first connection identifier (CID=1).

As referred to herein, MS 102, RAN 112, gateway 114, and feature server 162 are on an originating side of the call and may be referred to herein an originating MS, RAN, gateway, and feature server. Similarly, MS 104, RAN 122, gateway 124, and feature server 164 are on a first terminating side of the call and may be referred to herein as a first terminating MS, RAN, gateway, and feature server, and MS 106, RAN 132, gateway 134, and feature server 166 are on a second terminating side of the call and may be referred to herein as a second terminating MS, RAN, gateway, and feature server.

In response to receiving the first session invitation, originating feature server 162 assigns a second connection identifier (‘CID=2’) to the first dialogue, which second connection identifier is associated with a connection at the originating feature server to the first terminating feature server 164. Originating feature server 162 modifies the first session invitation, that is, the first SIP Invite, by replacing, in the contact header of the Invite, the first connection identifier with the second connection identifier (CID=2) and the source identifier associated with the originating MS 102 with a source identifier associated with the originating feature server (‘CON=IMS_FS’). Thus, originating feature server 162 identifies itself as the sender of the invitation instead of MS 102. The modified first session invitation further includes the destination identifier associated the called party, that is, MS 104 (SIP:USER 2 URI). Originating feature server 162 then conveys 406, 408 the modified first session invitation to the feature server serving the called, or first terminating, MS 104, that is, first terminating feature serve 164.

In response to receiving the modified first session invitation, the first terminating feature server 164 assigns a third connection identifier (‘CID=3’) to the first dialogue and to a connection at the first terminating feature server to first terminating MS 104. First terminating feature server 164 then further modifies the modified first session invitation by replacing, in the contact header, the second connection identifier with the third connection identifier (CID=3) and conveys 410, 412 the further modified first session invitation to the first terminating MS, that is, MS 104. The session invitation still includes the destination identifier associated with the called party, that is, MS 104 (SIP:USER 2 URI), and the source identifier associated with originating feature server 162 (CON=IMS_FS).

In response to receiving the modified first session invitation from first terminating feature server 164, first terminating MS 104 acknowledges 414 receipt of the first session invitation by conveying a SIP 200 OK message to IMS core network 152, and more particularly to the CSCF. The CSCF then notifies 416 originating MS 102 that MS 104 has been successfully located and is being notified of the call by conveying a SIP 180 Ringing message to MS 102. When a user of MS 104 then answers the call, MS 104 notifies 416 MS 102 that the call has been answered by conveying a SIP 200 OK message back to MS 102. MS 102 then acknowledges 416 receipt of the SIP 200 OK message by conveying a SIP ACK back to MS 104.

Further, in response to receiving the first session invitation, first terminating MS 104 generates a session description protocol (SDP) proposal. As is known in the art, a SDP proposal identifies the parties to the session and identifies the sending MS's capabilities by proposing parameters for participating in the session, for example, a session name and purpose, a type of media involved (video, audio, etc.), a format of the media, a transport protocol, and information needed to receive the media, such as addresses, ports, media formats, and the like. MS 104 then conveys a SIP Re-Invite back to IMS core network 152, and in particular the CSCF, that includes the third connection identifier (CID=3), a destination identifier associated with the MS 102 (‘SIP:USER 1 URI’), a source identifier associated with the sender of the SIP Re-Invite, that is, MS 104 (‘CON=USER2’), and the SDP proposal.

Further, in response to receiving the first session invitation, first terminating MS 104 determines to switch the call to a three-way, or conference, call. The determination may be automatically made based on instructions stored in the at least one memory device 204 of the MS or based on instructions input into the MS by a user of the MS via the user interface 206 of the MS, for example, by touching or depressing a call hold key and a three-way call key in the user interface. First terminating MS 104 assigns a fourth connection identifier (‘CID=4’) to a second dialogue and a connection at the first terminating MS to first terminating feature server 164. MS 104 then initiates the conference call by conveying 422, 424, to first terminating feature server 164, a request, preferably a second SIP Invite message, to initiate the three-way, or conference, call. The request includes a destination routing information that associated with the conference call feature (‘CC_FACT URI’) of SIP CC sever 168 and that is maintained in the at least one memory device 204 of the conference call initiator, that is, MS 104. The request to initiate the conference call further includes the fourth connection identifier (CID=4) and a source identifier associated with MS 104 (CON=USER2).

In response to receiving the second SIP Invite message, first terminating feature server 164 determines, based on the included routing information for the conference call feature, to forward the second SIP Invite to SIP CC server 168. First terminating feature server 164 further assigns a fifth connection identifier (‘CID=5’) to the second dialogue and a connection at the first terminating feature server 164 to SIP CC server 168. First terminating feature server 164 then modifies the second SIP Invite by replacing, in the contact header of the message, the fourth connection identifier with the fifth connection identifier (CID=5) and the source identifier associated with MS 104 with a source identifier associated with the first terminating feature server (‘CON=IMS_FS_O’). First terminating feature server 164 then forwards 426 the modified second SIP Invite message to the CSCF of IMS core network 152. The CSCF replaces the source identifier associated with first terminating feature server 164 (‘CON=IMS_FS_O’) with a source identifier associated with the CSCF and the first terminating feature server (‘CON=CSF_FS_O’) and forwards 428 the further modified second SIP Invite message to SIP CC server 168.

In response to receiving the modified second SIP Invite from the CSCF and based on the destination routing information associated with the conference call feature (CC_FACT URI), SIP CC server 168 notifies 430 media server 144 that a conference call is being set up. SIP CC server 168 requests conference call information from media server 144 and informs 432, 434 first terminating feature server 164 that media server 144 has been successfully contacted and is being notified of the conference call. Preferably, SIP CC server so informs first terminating feature server 164 by conveying a SIP 180 Ringing message to feature server 164, which message identifies the second dialogue by including the fifth connection identifier (CID=5). In turn, in response to receiving the SIP 180 Ringing message from originating feature server 162, first terminating feature server 164 modifies the SIP 180 Ringing message by replacing the fifth connection identifier with the fourth connection identifier (CID=4) and informs first terminating MS 104 that the conference call is being set up by forwarding 436, 438 the modified SIP 180 Ringing message to the first terminating MS.

In response to being notified of the conference call, media server 144 assigns a unique identifier, preferably a routing address (‘CC-URI’), to the requested conference call and generates an SDP proposal for the call, and provides the conference call identifier and SDP proposal to SIP CC server 168. Thus, SIP CC server 168 is able to determine a conference call identifier and a media server-based SDP proposal for the conference call. SIP CC server 168 then provides this information back to the conference call initiator, that is, MS 104.

More particularly, SIP CC server 168 acknowledges receipt of the modified second SIP Invite message by conveying 440, 442, back to first terminating feature server 164, a SIP 200 OK message that identifies the second dialogue by including the fifth connection identifier (CID=5), includes the SDP proposal received from the media server 144 (‘SDP=MRFP’), and includes the assigned conference call identifier (‘CON=CC-URI’). First terminating feature server 164 stores conference call identifier and SDP proposal and modifies the SIP 200 OK message by replacing, in the contact header, the fifth connection identifier with the fourth connection identifier (CID=4) and by replacing the assigned conference call identifier (CON=CC-URI) with a destination identifier associated with the first terminating feature server (CON=IMS_FS_O). First terminating feature server 164 then acknowledges receipt of the second SIP Invite message by conveying 444, 446 the modified SIP 200 OK message, which includes the media server SDP proposal (‘SDP=MRFP’), to first terminating MS 104.

In response to receiving the modified SIP 200 OK message from first terminating feature server 164, first terminating MS 104 acknowledges 448, 450 the modified SIP 200 OK message by conveying a SIP ACK, that includes the fourth connection identifier (CID=4), back to the first terminating feature server. In turn, first terminating feature server 164 acknowledges 452, 454 receiving the SIP 200 OK message from SIP CC server 168 by conveying a SIP ACK back to the SIP CC server, which SIP ACK includes the fifth connection identifier (CID=5).

In addition, in response to receiving the modified second SIP Invite, SIP CC server 168 then requests 456, 458, 460, 462 that first terminating MS 104 switch from a call whose end point is MS 102 to a conference call whose end point is media server 144. That is, SIP CC server 168 requests that first terminating MS 104 dial into the media server. Preferably, SIP CC server 168 requests that first terminating MS 104 switch to the media server by conveying a first SIP Refer message to MS 104, and more particularly conveys 456, 458 a first SIP Refer message to first terminating feature server 164. The first SIP Refer message includes a destination identifier associated with first terminating MS 104 (SIP:User 2 URI), a source identifier associated with the conference call feature (‘FROM-CC_FACT URI’), the identifier assigned to the conference call (‘CC-URI’), and the fifth connection identifier (CID=5). In response to receiving the first SIP Refer message from SIP CC server 168, first terminating feature server 164 modifies a contact header of first SIP Refer message by replacing the fifth connection identifier with the fourth connection identifier (CID=4) and conveys 460, 462 the modified first SIP Refer message to first terminating MS 104.

In response to receiving the modified first SIP Refer, first terminating MS 104 accepts 464, 466 the request to switch to a call to media server 144, preferably by conveying a SIP 202 Accepted message to the SIP CC server 168. More particularly, MS 104 conveys a SIP 202 Accepted message to first terminating feature server 164, which SIP 202 Accepted message identifies the second dialogue by including the fourth connection identifier (CID=4). In response to receiving the SIP 202 Accepted message, first terminating feature server 164 modifies the message by replacing the fourth connection identifier with the fifth connection identifier (CID=5). First terminating feature server 164 then conveys the modified SIP 202 Accepted message to the SIP CC server. SIP CC server 168 then acknowledges receipt of the modified SIP 202 Accepted message by conveying 472, 474 a SIP 200 OK message that includes the fifth connection identifier (CID=5) to first terminating feature server 164. First terminating feature server 164 modifies the SIP 200 OK message by replacing the fifth connection identifier with the fourth connection identifier (CID=4) and forwards the modified SIP 202 Accepted message to first terminating MS 104.

In addition, in response to being notified that first terminating MS 104 is going to dial into media server, SIP CC server 168 informs first terminating feature server 164 that the SIP CC server 168 is releasing SIP signaling resources associated with the second dialogue, that is, with fifth connection identifier (CID=5). Preferably, SIP CC server 168 so informs the first terminating feature server by conveying 472, 474 a first SIP Bye message to first terminating feature server 164 that includes the fifth connection identifier. In response to receiving the first SIP Bye message, first terminating feature server 164 acknowledges the first SIP Bye message by conveying a SIP 200 OK message to the SIP CC server 168 and the SIP CC server 168 closes the connection associated with the fifth connection identifier.

Further, in response to receiving the first SIP Bye message, first terminating feature server 164 modifies the message by replacing the fifth connection identifier with the fourth connection identifier (CID=4) and informs first terminating MS 104 that the first terminating feature server is releasing SIP resources associated with the second dialogue by conveying 476, 478 the modified first SIP Bye message, comprising the fourth connection identifier, to the MS. In response to receiving the first SIP Bye message, first terminating MS 104 acknowledges the modified first SIP Bye message by conveying a SIP 200 OK message to the first terminating feature server 164 and the first terminating feature server closes the connection associated with the fourth connection identifier.

In addition, since the first terminating MS 104 has accepted the request to dial into the conference call, an operator of communication system 100 may desire to provide the conference call identifier (CC-URI) for display to a user of MS 104. In such event, SIP CC server 168 may convey 482, 484, 486, 488, to MS 104 via first terminating feature server 164, a SIP Message that includes, in a payload of the message, text informing of the conference call identifier. When MS 104 receives 486, 488 the SIP Message, the MS acknowledges 482, 484, 486, 488 receipt of the message by conveying a SIP 200 OK message back to SIP CC server 168 via first terminating feature server 164 and displays the conference call identifier on a display screen of the sure interface 206 of the MS.

In response to receiving the modified first SIP Bye message from first terminating feature server 164 informing of the termination of the second dialogue, first terminating MS 104 assigns a sixth connection identifier (‘CID=6’) to a new, third dialogue that is associated with the conference call being initiated by the MS 104 and is associated with a new connection to first terminating feature server 164. First terminating MS 104 then initiates the new dialogue by conveying 490, 492 an invitation to the conference call, preferably a third SIP Invite, to first terminating feature server 164. The third SIP Invite includes a destination identifier associated with the conference call feature (SIP:CC-URI), the sixth connection identifier (CID=6), and a source identifier associated with first terminating MS (CON=USER2).

In response to receiving the third SIP Invite, first terminating feature server 164 assigns a new, seventh connection identifier (‘CID=7’) to the third dialogue and to a new connection to SIP CC server 168. First terminating feature server 164 then modifies the third SIP Invite by replacing the sixth connection identifier with the seventh connection identifier (CID=7) and replacing the source identifier associated with MS 104 (CON=USER2), as the sender of the third SIP Invite, with a source identifier associated with the first terminating feature server 164 (CON=IMS_FS_O). First terminating feature server 164 then conveys 494, 496 the modified third SIP Invite to SIP CC server 168.

Further, first terminating MS 104 responds to the first SIP Refer message (signal 462) by providing, to SIP CC server 168, an update on the status of MS 104's switch from the call with MS 102 to the conference call. More specifically, MS 104 conveys 500, 502 a first SIP Notify message to first terminating feature server 164. The first SIP Notify message includes a source identifier associated with first terminating feature server 164 (CON=IMS_FS_O), the fourth connection identifier (CID=4), and a SIP 100 Trying indicator. The SIP 100 Trying indicator informs that the Refer message has been received and that the switch to the conference call is being attempted but has not yet been accomplished. In response to receiving the first SIP Notify message, first terminating feature server 164 modifies the first SIP Notify message by replacing the fourth connection identifier with the fifth connection identifier (CID=5) and forwards 504, 506 the modified first SIP Notify message to SIP CC server 168. SIP CC server 168 then acknowledges receiving the first SIP Notify message by conveying a SIP 200 OK back to MS 104 via first terminating feature server 164.

Referring again to the third SIP Invite, in response to receiving (signal 496) the third SIP Invite, SIP CC server 168 sets up 498 a media session for the conference call with media server 144. In response to setting up the connection, SIP CC server 168 acknowledges receipt of the third SIP Invite and informs first terminating MS 104 that the session has been set up by conveying 508, 510, 512, 514 a SIP 200 OK message back to the MS. More specifically, SIP CC server 168 conveys 508, 510 a SIP 200 OK message to first terminating feature server 164, which SIP 200 OK message includes the assigned conference call identifier (CON=CC-URI) and identifies the third dialogue by including the seventh connection identifier (CID=7). In turn, first terminating feature server 164 modifies the SIP 200 OK message by replacing the seventh connection identifier with the sixth connection identifier (CID=6) and the assigned conference call identifier (CON=CC-URI) with a destination identifier associated with the first terminating feature server (CON=IMS_FS_O), and forwards 512, 514 the modified SIP 200 OK message to MS 104.

In response to being informed, by SIP CC server 168, that the media session at media server 144 has been set up for the conference call, that is, to receiving the modified SIP 200 OK message, first terminating MS 104 dials into media server 144. When first terminating MS 104 successfully accesses media server 144, first terminating MS 104 notifies 516, 518 first terminating feature server 164 of the successful access by conveying 516, 518, 520, 522 a second SIP Notify message to SIP CC server 168. More specifically, first terminating MS 104 conveys 516, 518 the second SIP Notify message to first terminating server 164, which message includes a destination identifier associated with the first terminating feature server (CON=IMS_FS_O) and identifies the second dialogue by including the fourth connection identifier (CID=4). The second SIP Notify message further identifies the SIP 200 OK message being responded to. In response to receiving the second SIP Notify message, first terminating feature server 164 modifies the message by replacing the fourth connection identifier with the fifth connection identifier (CID=5). First terminating feature server 164 then conveys 520, 522 the modified second SIP Notify message to SIP CC server 168. SIP CC server 168 then acknowledges 520, 522 receipt of the modified second SIP Notify message by conveying 516, 518, 520, 522 a SIP 200 OK message back to the first terminating MS 104 via first terminating feature server 164.

Further, first terminating MS 104 acknowledges 524, 526, 528, 530 receipt of the third dialogue SIP 200 OK message (signal 514) from SIP CC server 168 by conveying 524, 526 a SIP ACK message back to the SIP CC server. More particularly, first terminating MS 104 conveys 524, 526 a SIP ACK message to first terminating feature server 164 that identifies the third dialogue by including the sixth connection identifier (CID=6). First terminating feature server 164 modifies SIP ACK message by replacing the sixth connection identifier with the seventh connection identifier (CID=7) and conveys 528, 530 the modified SIP ACK message to SIP CC server 168.

After dialing into media server 144, first terminating MS 104 dial into the conference call at media server 144 and sets up 532 a media session, such as a Real Time Protocol (RTP) flow, with the media server in accordance with well-known techniques. First terminating MS 104 then requests that originating MS 102 switch to the conference call, preferably by conveying a SIP Refer message back to SIP CC server 168. More particularly, first terminating MS 104 conveys 534, 536 a second SIP Refer message to first terminating feature server 164. The second SIP Refer message includes a first destination identifier associated with the first terminating feature server (SIP:IMS_FS_O), informs that the Refer is intended for MS 102 (‘REFER TO=USER1’), and includes a source identifier associated with MS 104 (‘REFER BY=USER2’). The second SIP Refer message further informs that the third dialogue, associated with the included sixth connection identifier (CID=6), is to replace the first dialogue associated with the third connection identifier (CID=3). In response to receiving the second SIP Refer message, first terminating feature server 164 modifies the second SIP Refer message by replacing the sixth connection identifier with the seventh connection identifier (CID=7) and the destination identifier associated with the first terminating feature server with the assigned conference call identifier (SIP:CC-URI). First terminating feature server 164 then conveys 538, 540 the modified second SIP Refer message to SIP CC server 168.

In response to receiving the modified second SIP Refer message, SIP CC server 168 agrees to request MS 102 to switch to the conference call and so informs MS 104, preferably by conveying a SIP Accepted message to the MS. More particularly, SIP CC server 168 conveys 542, 544 a SIP Accepted message to first terminating feature server 164, which SIP Accepted message identifies the third dialogue by including the seventh connection identifier (CID=7). First terminating feature server 164 modifies the SIP Accepted message by replacing the seventh connection identifier with the sixth connection identifier (CID=6) and conveys the modified SIP Accepted message to first terminating MS 104.

Further in response to receiving the modified second SIP Refer message from MS 104, SIP CC server 168 invites originating MS 102 to participate in the conference call and provides MS 102 with the identifier assigned to the conference call so that the MS can dial into the media server. More particularly, SIP CC server 168 generates an eighth connection identifier (CID=8) associated with the third dialogue and a connection at the SIP CC server to originating feature server 162. SIP CC server 168 then assembles a fourth session invitation, preferably a fourth SIP Invite message, and conveys 550, 552 the fourth session invitation to originating feature server 162. The fourth session invitation includes the assigned conference call identifier (CON=CC-URI), a destination identifier associated with MS 102 (SIP:User 1 URI), the eighth connection identifier (CID=8) associated with the third dialogue, and the media server SDP proposal (SDP=MRFP). The fourth SIP Invite message further informs that the third dialogue, associated with the eighth connection identifier (CID=8), is replacing the first dialogue that is associated with the second connection identifier (CID=2).

In response to receiving the fourth SIP Invite message, originating feature server 162 generates a ninth connection identifier (CID=9) associated with the third dialogue and a connection to originating MS 102. Originating feature server 162 then modifies the fourth SIP Invite message by replacing the eighth connection identifier with the ninth connection identifier (CID=9) and by replacing the second connection identifier with the first connection identifier (CID=1), thereby informing that the third dialogue, associated with the ninth connection identifier, is to replace the first dialogue, associated with the first connection identifier. Originating feature server 162 then conveys 554, 556 the modified fourth SIP Invite message to originating MS 102. In addition, in response to receiving the fourth SIP Invite message, originating feature server 162 sets up 558 a media session with media server 144. Originating MS 102 then acknowledges 576, 578, 580, 582 receipt of the fourth SIP Invite message by conveying a SIP 200 OK message back to SIP CC server 168. More particularly, originating MS 102 conveys 576, 578 a SIP 200 OK message that includes the ninth connection identifier (CID=9) to originating feature server 162. Originating feature server 162 modifies the SIP 200 OK message by replacing the ninth connection identifier with the eighth connection identifier (CID=8) and conveys 580, 582 the modified SIP 200 OK message to SIP CC server 168.

Further, in response to receiving the fourth SIP Invite message, originating MS 102 determines to release resources associated with the first dialogue, that is, the dialogue associated with the first connection identifier (CID=1). Originating MS 102 informs originating feature server 162 of its intention release resources associated with the first dialogue by conveying 584, 586 a second SIP Bye message to originating feature server 162 that includes the first connection identifier. Originating feature server 162 acknowledges 584, 586 the second SIP Bye message by conveying a SIP 200 OK message back to originating MS 102 and the originating MS closes the connection associated with the first connection identifier. Originating feature server 162 further modifies the second SIP Bye message by replacing the first connection identifier with the second connection identifier (CID=2) and informs first terminating feature server 164 that it is releasing resources associated with the first dialogue, that is, the dialogue associated with the second connection identifier, by conveying 588, 590 the modified second SIP Bye message to the first terminating feature server 164. First terminating feature server 164 acknowledges 588, 590 the second SIP Bye message by conveying a SIP 200 OK message back to originating feature server 162 and the originating feature server closes connections associated with the second connection identifier.

First terminating feature server 164 modifies the modified second SIP Bye message by replacing the second connection identifier with the third connection identifier (CID=3) and informs first terminating MS 104 that it is releasing resources associated with the first dialogue, that is, the dialogue associated with the third connection identifier, by conveying 592, 594 the further modified second SIP Bye message to first terminating MS 104. First terminating MS 104 acknowledges 592, 594 the second SIP Bye message by conveying a SIP 200 OK message back to first terminating feature server 164 and the first terminating feature server closes connections associated with the third connection identifier.

Meanwhile, SIP CC server 168 provides 560, 562, 564, 566 first terminating MS 104 with an update on the status of the request to invite MS 102 to the conference call. More particularly, SIP CC server 168 conveys 560, 562, to first terminating feature server 164, a third SIP Notify message that includes a destination identifier associated with MS 104 (SIP:User 2 URI), the seventh connection identifier (CID=7), and a SIP 100 Trying message. The SIP 100 Trying message informs that the request to invite MS 102 to the conference call has been received and that the request is being processed but has not yet been accomplished. First terminating feature server 164 then modifies the third SIP Notify message by replacing the seventh connection identifier with the sixth connection identifier (CID=6) and forwards 564, 566 the modified third SIP Notify message to MS 104. First terminating MS 104 then acknowledges 568, 570, 572, 574 successful receipt of the modified third SIP Notify message by conveying a SIP 200 OK message back to SIP CC server 168. More particularly, first terminating MS 104 conveys 568, 570 a SIP 200 OK message that includes the sixth connection identifier (CID=6) to first terminating feature server 164. First terminating feature server 164 modifies the SIP 200 OK message by replacing the sixth connection identifier with the seventh connection identifier (CID=7) and conveys 572, 574 the modified SIP 200 OK message to SIP CC server 168.

In response to receiving the modified SIP 200 OK message (signal 582), SIP CC server 168 notifies 596, 598, 600, 602, first terminating MS 104 that MS 102 has answered the conference call, preferably by conveying 560, 562 a fourth SIP Notify message to first terminating first terminating MS 104. More particularly, SIP CC server 168 conveys a fourth SIP Notify message to feature server 164, which fourth SIP Notify message includes a destination identifier associated with MS 104 (SIP:USER 2 URI), includes the seventh connection identifier (CID=7), and identifies the SIP 200 OK message. First terminating feature server 164 then modifies the fourth SIP Notify message by replacing the seventh connection identifier with the sixth connection identifier (CID=6) and forwards 600, 602 the modified fourth SIP Notify message to MS 104.

In addition, in response to receiving the modified SIP 200 OK (signal 582), SIP CC server 168 acknowledges 604, 606, 608, 610 receipt of the message by conveying a SIP ACK message back to originating MS 102. More particularly, SIP CC server 168 conveys 604, 606 a SIP ACK message that includes the eighth connection identifier (CID=8) to originating feature server 162. Originating feature server 162 modifies the SIP ACK message by replacing the eighth connection identifier with the ninth connection identifier (CID=9) and conveys 608, 610 the modified SIP ACK message to MS 102.

Further, in response to receiving the modified fourth SIP Invite, originating MS 102 dials into the conference call at media server 144 and sets up 612 a media session, such as a Real Time Protocol (RTP) flow, with the media server. Media server 144 then links the media sessions set up by each of MS 102 and MS 104 and a bearer link is established 612, 614 between MSs 102 and 104 via the media server.

First terminating MS 104 may now invite another MS, such as second terminating MS 106, to join the conference call. However, one of ordinary skill in the art realizes that first terminating MS 104 may invite second terminating MS 106 to participate in the conference call at any time after the third dialogue has been set up, that is, after the sixth and seventh connection identifiers are assigned.

First terminating MS 104 initiates the addition of a third MS, or a second terminating MS, that is, MS 106, to the conference call by conveying a request to SIP CC server 168 to add the second terminating MS to the conference call, preferably by conveying a third SIP Refer message to SIP CC server 168. More particularly, first terminating MS 104 conveys 616, 618 a third SIP Refer message to first terminating feature server 164, which third SIP Refer message includes a first destination identifier associated with the first terminating feature server (SIP:IMS_FS_O) and a second destination identifier that identifies second terminating MS 106 as the device being requested to be added (REFER TO=USER 3). The third SIP Refer message further identifies the third dialogue by including the sixth connection identifier (CID=6) and includes a source identifier associated with MS 104 (REFER BY=USER2). In response to receiving the third SIP Refer message, first terminating feature server 164 modifies the third SIP Refer message by replacing the sixth connection identifier with the seventh connection identifier (CID=7) and by replacing the first destination identifier, associated with the first terminating feature server, with a destination identifier corresponding to the identifier assigned to the conference call (SIP:CC-URI). First terminating feature server 164 then conveys 620, 622 the modified third SIP Refer message to SIP CC server 168.

In response to receiving the modified third SIP Refer message, SIP CC server 168 conveys 624, 626, 628, 630 a fifth session invitation, preferably a fifth SIP Invite, to second terminating MS 106. More particularly, SIP CC server 168 assigns a tenth connection identifier ‘(CID=10’) to the third dialogue and to a connection at the SIP CC server with second terminating feature server 166. SIP CC server 168 then conveys 624, 626 the fifth session invitation, that is, the fifth SIP Invite, to second terminating feature server 166, which fifth session invitation includes a destination identifier associated with the second terminating MS (‘SIP:User 3 URI’) and includes the tenth connection identifier (CID=10). In response to receiving the fifth session invitation, second terminating feature server 166 assigns an eleventh connection identifier (‘CID=11’) to the third dialogue and to a connection at the second terminating feature server to second terminating MS 106. Second terminating feature server 166 then modifies the fifth SIP Invite by replacing the tenth connection identifier with the eleventh connection identifier (CID=11), and conveys 628, 630 the modified fifth SIP Invite to second terminating MS 106.

In response to receiving the modified fifth SIP Invite, second terminating MS 106 dials into media server 144. Second terminating MS 106 then sets up 632 a media session, such as a Real Time Protocol (RTP) flow, with the media server and the media server then links the media session set up by MS 106 with the media session set up by each of MS 102 and MS 104, and bearer links are established among the MSs 102, 104, and 106 via the media server as is known in the art.

Communication system 100 further provides for a participating MS, such as MS 102, to invite a wireline communication device 172, such as a wireline telephone, to participate in the call. For example, suppose MS 102 wants to invite wireline communication device 172 associated with a wireline telephone number, such as a PSTN telephone number, to join the call. For example, a user of MS 102 may dial the PSTN telephone number for wireline communication device 172 into MS 102. MS 102 then initiates the addition of wireline communication device 172 to the call by conveying 634, 636 a SIP Refer message to the feature server serving the MS, that is, feature server 162. The SIP Refer message includes a first destination identifier associated with the originating feature server 162 (SIP:IMS_FS) and a second destination identifier associated with the wireline communication device being requested to join (‘REFER TO-<PSTN TELEPHONE NO.>’). The SIP Refer message further includes the ninth connection identifier (CID=9) and a source identifier associated with MS 102 (REFER BY=USER1).

In response to receiving the SIP Refer message from MS 102, originating feature server 162 modifies the SIP Refer message by replacing the ninth connection identifier with the eighth connection identifier (CID=8) and by replacing the destination identifier associated with the originating feature server with the assigned conference call identifier (SIP:CC-URI). First terminating feature server 164 then conveys 638, 640 the modified SIP Refer message to SIP CC server 168.

In response to receiving the modified SIP Refer message, SIP CC server 168 conveys 642, 644 conveys a session invitation, preferably a SIP Invite, to media gateway 146. The SIP Invite includes the routing information for wireline communication device 172 (‘<PSTN TELEPHONE NO.>’) and the ninth connection identifier (CID=9). Based on the SIP Invite, media gateway 146 signals 642 wireline circuit switched network 170, such as a PSTN, to set up a call between wireline communication device 172 and the media gateway in accordance with well-known techniques. In turn, media gateway 146 sets up 648 a media session, such as a Real Time Protocol (RTP) flow, with the conference call feature of media server 144, sets up a call 650 with the wireline communication device 172 via PSTN 170, and then links the media session and call together.

By providing for a propagation of an assigned conference call identifier throughout the communication system, communication system 100 provides for each mobile station participating in a conference call, or three-way call, to know an address to dial into for the call. The communication system facilitates propagation of such an identifier despite the involvement of multiple features servers, or B2BUAs, in an IMS-based signaling path between a first MS, that originates a call, and a second MS, that switches the call to a conference call.

While the present invention has been particularly shown and described with reference to particular embodiments thereof, it will be understood by those skilled in the art that various changes may be made and equivalents substituted for elements thereof without departing from the scope of the invention as set forth in the claims below. Accordingly, the specification and figures are to be regarded in an illustrative rather then a restrictive sense, and all such changes and substitutions are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, “conference call” and “three-way call” are interchangeable terms. Further, as used here, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus. The terms ‘including’ and/or ‘having’, as used herein, are defined as comprising. Furthermore, unless otherwise indicated herein, the use of relational terms, if any, such as first and second, top and bottom, and the like are used solely to distinguish one entity or action from another entity or action without necessarily requiring or implying any actual such relationship or order between such entities or actions. An element preceded by “a . . . ” does not, without more constraints, preclude the existence of additional identical elements in the process, method, article, or apparatus.

1. A method for an Internet Protocol Multimedia Subsystem-based three way call, the method comprising:
receiving a request from a conference call initiator to switch a call to a conference call;
assigning a unique identifier to the conference call; and
providing the conference call identifier to the conference call initiator via one or more of a Session Initiation Protocol messaging.

2. An Internet Protocol Multimedia Subsystem network server comprising a processor that is configured to receive a request from a conference call initiator to switch a call to a conference call, determine a unique identifier for the conference call, and provide the conference call identifier to the conference call initiator via Session Initiation Protocol messaging.

3. A mobile station capable of participating in an Internet Protocol Multimedia Subsystem (IMS)-based three way call, the mobile station comprising a processor that is configured to receive invitation to participate in a call, determine to switch the call to a three way call, convey a request to an IMS network to switch the call to a conference call, receive a unique identifier for the conference call from the IMS network via one or more of a Session Initiation Protocol Refer message, Message message, and Notify message, and dial into the conference call based on the received conference call identifier.

4. The method of claim 1, wherein the Session Initiation Protocol messaging comprises one or more of a Session Initiation Protocol Refer message, a Session Initiation Protocol Message message, and a Session Initiation Protocol 200 OK message.

5. The method of claim 1, wherein the call is an Internet Protocol Multimedia Subsystem telephony session, wherein the conference call initiator is a terminating mobile station, and wherein the method further comprises originating, by an originating mobile station, the call involving the terminating mobile station.

6. The method of claim 5, wherein assigning a unique identifier to the conference call comprises:
notifying a media server, by an Internet Protocol Multimedia Subsystem server, of the conference call;
assigning, by the media server, a unique identifier to the conference call; and
receiving, by the Internet Protocol Multimedia Subsystem server from the media server, the conference call identifier; and
wherein providing the conference call identifier comprises providing the conference call identifier by the Internet Protocol Multimedia Subsystem server to the conference call initiator.

7. The method of claim 6, further comprising:
receiving, by the Internet Protocol Multimedia Subsystem server from the media server, a Session Description Protocol proposal; and
providing the Session Description Protocol proposal to the conference call initiator.

8. The method of claim 6, wherein providing the conference call identifier to the conference call initiator comprises:
providing the conference call identifier, by the Internet Protocol Multimedia Subsystem server to an Internet Protocol Multimedia Subsystem-based user agent associated with the conference call initiator, via Session Initiation Protocol messaging; and
providing the conference call identifier, by the Internet Protocol Multimedia Subsystem-based user agent associated with the conference call initiator to the conference call initiator, via Session Initiation Protocol messaging.

9. The method of claim 8, further comprising, in response to receiving, by the conference call initiator, the conference call identifier:
dialing into the media server by the conference call initiator;
requesting, by the conference call initiator to the Internet Protocol Multimedia Subsystem-based user agent associated with the conference call initiator, that the originating mobile station switch to the conference call;
requesting, by the Internet Protocol Multimedia Subsystem-based user agent associated with the conference call initiator to the Internet Protocol Multimedia Subsystem server, that the originating mobile station switch to the conference call, wherein the request comprises the conference call identifier;
requesting, by the Internet Protocol Multimedia Subsystem server, that the originating mobile station participate in the conference call, wherein the request comprises the conference call identifier.

10. The method of claim 9, wherein requesting that the originating mobile station participate in the conference call comprises:
conveying, by the Internet Protocol Multimedia Subsystem server to an Internet Protocol Multimedia Subsystem-based user agent associated with the originating mobile station, Session Initiation Protocol messaging requesting that the originating mobile station participate in the conference call, wherein the Session Initiation Protocol messaging comprises the conference call identifier; and
conveying, by the Internet Protocol Multimedia Subsystem-based user agent associated with the originating mobile station to the originating mobile station, Session Initiation Protocol messaging requesting that the originating mobile station participate in the conference call, wherein the Session Initiation Protocol messaging conveyed to the originating mobile station comprises the conference call identifier.

11. The method of claim 10, further comprising, in response to receiving, by the originating mobile station, the conference call identifier:
releasing, by the originating mobile station, resources associated with the call originated by the originating mobile station; and
setting up, by the originating mobile station, a media session with the media server.

12. The method of claim 9, wherein the conference call initiator is first terminating mobile station and wherein the method further comprises:
conveying, by the first terminating mobile station to the Internet Protocol Multimedia Subsystem-based user agent associated with the conference call initiator, a request that a second terminating mobile station join the conference call;
in response to receiving the request from the first terminating mobile station, conveying by the Internet Protocol Multimedia Subsystem-based user agent associated with the conference call initiator to the Internet Protocol Multimedia Subsystem server, a request that a second terminating mobile station to participate in the conference call, wherein the request comprises the conference call identifier; and
in response to receiving the request from the Internet Protocol Multimedia Subsystem-based user agent associated with the conference call initiator, conveying by the Internet Protocol Multimedia Subsystem server to the second terminating mobile station, a request to participate in the conference call.

13. The Internet Protocol Multimedia Subsystem network server of claim 2, wherein the Session Initiation Protocol messaging comprises one or more of a Session Initiation Protocol Refer message, a Session Initiation Protocol Message message, and a Session Initiation Protocol 200 OK message.

14. The Internet Protocol Multimedia Subsystem network server of claim 2, wherein the processor is configured to determine a unique identifier for the conference call by notifying a media server of the conference call and, in response, receiving the conference call identifier from the media server.

15. The Internet Protocol Multimedia Subsystem network server of claim 14, wherein the processor is configured to receive a Session Description Protocol proposal from the media server and to provide the Session Description Protocol proposal to the conference call initiator.

16. A system comprising the Internet Protocol Multimedia Subsystem network server of claim 14 and further comprising an Internet Protocol Multimedia Subsystem-based user agent associated with the conference call initiator, wherein the Internet Protocol Multimedia Subsystem network server provides the conference call identifier to the conference call initiator by providing the conference call identifier to the conference call initiator via the Internet Protocol Multimedia Subsystem-based user agent associated with the conference call initiator.

17. The system of claim 16,
wherein the Internet Protocol Multimedia Subsystem-based user agent associated with the conference call initiator is configured to receive a request, from the conference call initiator, that the originating mobile station switch to the conference call, and in response to receiving the request from the conference call initiator, convey a request, to the Internet Protocol Multimedia Subsystem server, that the originating mobile station switch to the conference call, wherein the request comprises the conference call identifier, and
wherein the Internet Protocol Multimedia Subsystem server processor is configured to, in response to receiving the request from the Internet Protocol Multimedia Subsystem-based user agent associated with the conference call initiator, convey a request to the originating mobile station to participate in the conference call, wherein the request comprises the conference call identifier.

18. The system of claim 17, further comprising an Internet Protocol Multimedia Subsystem-based user agent associated with the originating mobile station,
wherein the Internet Protocol Multimedia Subsystem server processor is configured to convey a request to the originating mobile station to participate in the conference call by conveying SIP messaging to the Internet Protocol Multimedia Subsystem-based user agent associated with the originating mobile station requesting that the originating mobile station to participate in the conference call, wherein the SIP messaging conveyed to the Internet Protocol Multimedia Subsystem-based user agent associated with the originating mobile station comprises the conference call identifier, and
wherein the Internet Protocol Multimedia Subsystem-based user agent associated with the originating mobile station is configured to convey SIP messaging to the originating mobile station requesting that the originating mobile station participate in the conference call, wherein SIP messaging conveyed to the originating mobile station comprises the conference call identifier.

19. The system of claim 18, wherein the Internet Protocol Multimedia Subsystem-based user agent associated with the originating mobile station is configured to, in response conveying the request to participate in the conference call to the originating mobile station, receive a message from the originating mobile station informing that the originating mobile station intends to release resources associated with the call originated by the originating mobile station and, in response to receiving the message informing that the originating mobile station intends to release resources associated with the call originated by the originating mobile station, inform the Internet Protocol Multimedia Subsystem-based user agent associated with the conference call initiator that resources associated with the call originated by the originating mobile station are being released.

20. The system of claim 19, wherein the conference call initiator is first terminating mobile station,
wherein the Internet Protocol Multimedia Subsystem-based user agent associated with the conference call initiator is configured to receive, from the first terminating mobile station, a request that a second terminating mobile station join the conference call and, in response to receiving the request from the first terminating mobile station, convey, to the Internet Protocol Multimedia Subsystem server, a request that a second terminating mobile station to participate in the conference call, wherein the request comprises the conference call identifier; and
wherein the Internet Protocol Multimedia Subsystem server processor is configured to, in response to receiving the request that a second terminating mobile station to participate in the conference call, convey, to the second terminating mobile station, a request to participate in the conference call.
